(19) United States
(12) Patent Application Publication
(10) Pub. No.: US 2010/0015584 A1
(43) Pub. Date: Jan. 21, 2010

(54) Behavior Modification with Intermittent Reward

(76) Inventors: Michael S. Singer, Newton, MA (US); Murat V. Kalayoglu, Boston, MA (US)

Correspondence Address: FISH & RICHARDSON PC, P.O. BOX 1022, MINNEAPOLIS, MN, 55440-1022, US

(21) Appl. No.: 12/502,003

(22) Filed: Jul. 13, 2009

Related U.S. Application Data
(63) Continuation-in-part of application No. PCT/US2008/050896, filed on Jan. 11, 2008.
(60) Provisional application No. 60/880,248, filed on Jan. 12, 2007.

(51) Int. Cl. G09B 19/00

(52) U.S. Cl. 434/236

(57) ABSTRACT

The invention relates to simple yet effective methods, referred to herein as Dynamic Intermittent Reward or Reinforcement (DIR), and systems, to increase the frequency of a desired behavior in a user, and optimize cost-effectiveness of a reward system. A principal benefit of the new methods is the ability to provide tailored intermittent rewards for one or more users over time. The invention further relates to other methods, referred to herein as Tabular Intermittent Reward or Reinforcement (TIR), and systems, to administer intermittent rewards without an element of chance.

### CROSS-REFERENCE TO RELATED APPLICATIONS

This application is a continuation-in-part application of, and claims priority under 35 U.S.C. § 120 to, International Application Serial No. PCT/US2008/050896, filed on Jan. 11, 2008, which claims priority from U.S. Provisional Application Ser. No. 60/880,248, filed on Jan. 11, 2007. The contents of the foregoing applications are incorporated herein by reference in their entireties.

### TECHNICAL FIELD

This invention relates to new systems and methods for behavior modification.

### BACKGROUND

Much of human behavior is shaped by incentives and disincentives. Businesses entice customers with discounts, rebates, free merchandise, complimentary services, and sweepstakes. They also use disincentives such as late payment fees, interest on unpaid balances, and “late fees” for rental cars, videos, or other rented equipment. Employers motivate employees with commissions, bonuses, overtime pay, promotions, raises, and benefits. They use disincentives such as forfeited raises, missed promotions, probation, and termination. Governments elicit desired behaviors with tax reductions, financial awards, loans, contracts, and licenses. They use deterrents in the form of criminal, civil, and administrative penalties.

Behavior reinforcement is the formal term for a process that uses reward or punishment to increase the frequency of a desired behavior. For practical reasons, the most suitable reinforcement in commerce is usually a reward. Important parameters in behavior therapy are the schedule and immediacy of reinforcement. It is important to draw the distinction between a continuous schedule, whereby every instance of desired behavior is rewarded, and an intermittent reward schedule, whereby rewards occur only with some instances of the desired behavior. A specific type of intermittent schedule is the variable-ratio schedule, in which reward frequency fluctuates. Likewise, the value of rewards can vary, even if reward frequency is continuous or fixed. Variable-ratio schedules tend to motivate people more than if the same amount of reward were distributed on a continuous schedule. This is partly because variable-ratio intermittent reward leads to emotions of anticipation, suspense, and pleasure. It appears to involve key reward centers in the brain. The immediacy of the reward, i.e., the delay between the behavior and the reinforcement, is ideal if kept to a minimum. The variable-ratio schedule is to be contrasted with a fixed-ratio intermittent schedule, for example, a predictable reward every third time a desired behavior is performed.

Familiar examples of continuous rewards include: “20 percent off all athletic shoes;” “buy a pint of ice cream and receive a free bottle of chocolate syrup;” a 10 percent commission for a salesperson; a dollar-for-dollar federal tax credit for money spent on university tuition; and a mother who pays her son $5 for every “A” on his report card. Examples of an intermittent, fixed-ratio reward include: “buy 10 cups of coffee, and your next one is free” and “stay at our hotel 20 times and receive a free weekend stay.” Examples of an intermittent, variable-ratio reward include: a charity raffle, a state lottery, and “look under the bottle cap for a chance to win a European vacation.”

Intermittent reward is particularly effective for behaviors for which repeated performance is desired. In contrast to other methods, intermittent reward tends to elicit more intense and durable behavioral responses. With current methods of intermittent reward, however, a limitation is that the value and frequency of reward are not tailored to each user. For example, the multiple lots of a lottery or multiple entries of a sweepstakes each carry equal odds, irrespective of who purchases the lot(s) or enters the sweepstakes. With lotteries, such conditions are necessary for fairness and potentially for lawfulness.

A further problem is that commercial applications of intermittent reward usually rely on an element of chance. The element of chance is used to render the value, frequency, or occurrence of reward(s) unpredictable to a user, e.g., a consumer, who has a chance of receiving a reward. A common example is a sweepstakes, which appeals to consumers.

The law typically defines a sweepstakes as a promotion wherein: (1) an entrant can enter for free; (2) an entrant can win a reward (or prize); and (3) the reward depends on an element of chance (or randomness). Laws in the United States and many nations place limitations on how sweepstakes can be operated. In some cases these limitations render a sweepstakes more costly and less practical for a sponsor, depending on its objectives. For example, sweepstakes connected with the purchase of a product must provide an “Alternative Method of Entry (AMOE),” whereby a user who does not purchase the product can enter the sweepstakes and receive the same chances of winning the same prize as if he or she had entered through purchasing the product. AMOE can undermine the economics of a potential sweepstakes to the point of impracticality.

From the above definition of a sweepstakes, one can surmise that if a promotion has no element of chance, then it is not a sweepstakes. Two widely appreciated drawbacks to this approach, however, are that: (1) it would diminish the “excitement” of a promotion and (2) it would allow users to predict the outcome of the promotion and thereby derive excessive rewards from the sponsor.

### SUMMARY

The invention relates to simple yet effective methods, referred to herein as Dynamic Intermittent Reward or Reinforcement (DIR), and systems, to increase the frequency of a desired behavior in a user, and optimize cost-effectiveness of a reward system. A principal benefit of the invention is the ability to provide tailored intermittent rewards for one or more users over time. The invention further relates to other methods, referred to herein as Tabular Intermittent Reward or Reinforcement (TIR), and systems, to administer intermittent rewards without an element of chance.

The new methods are particularly useful for, but not limited to, applications that involve a recurrent, scheduled behavior, such as medication adherence (e.g., taking prescription medications on schedule, e.g., for treating asthma, diabetes (e.g., control blood sugar levels), elevated blood pressure, elevated cholesterol, e.g., statins, and other long and short term medications), health maintenance behavior (e.g., exercise and smoking cessation), equipment maintenance (e.g., automobile maintenance), attendance at a workplace or course of instruction, attention to an advertisement, purchase of a consumable product, or remittance of a payment.

In one aspect, the invention includes DIR methods for obtaining a desired behavior from a user, e.g., to determine tailored intermittent reward(s) for a user where a reward value is modulated. The methods include obtaining and/or maintaining a behavior adherence history for the user; calculating a behavior adherence rate from the behavior adherence history; determining whether a reward should be provided; if a reward is to be provided, determining a reward value, wherein the value of the reward is inversely correlated with the behavior adherence rate; and providing the user with a reward report indicating whether a reward is to be awarded and if so, the reward value.

For example, the methods can be computer-implemented DIR methods for obtaining a desired behavior from a user, and are performed by one or more processors, e.g., via contact centers are described herein. These methods include storing in a memory a behavior adherence history for the user; calculating a behavior adherence rate from the behavior adherence history; determining whether a reward should be provided; if a reward is to be provided, determining a reward value, wherein the value of the reward is inversely correlated with the behavior adherence rate; and providing the user with a reward report indicating whether a reward is to be awarded and if so, the reward value.

In another aspect, the invention features methods for obtaining a desired behavior from a user using DIR, e.g., where reward frequency, rather than value, is modulated. Of course, both value and frequency can be modulated.

These methods include obtaining and/or maintaining a behavior adherence history for the user; calculating a behavior adherence rate from the behavior adherence history; determining whether a reward should be provided for a given adherence event as a function of the user's behavior adherence rate, wherein the likelihood that a reward is provided is inversely correlated with the behavior adherence rate; if a reward is to be provided, determining a reward value; and providing the user with a reward report indicating whether a reward is to be awarded and if so, the reward value.

In some embodiments, these methods can further include identifying the user and retrieving the user's behavior adherence history, recording a most recent behavior in the user's behavior adherence history, providing to the user a user identification code, and obtaining the user identification code to identify the user.

In various embodiments, the behavior adherence rate can be calculated by determining a first number of times the user performed the desired behavior over a specified period of time, and dividing the first number of times by a second number of times the user is expected to perform the desired behavior over the period of time. In certain embodiments, the behavior adherence rate can be calculated by calculating a function of a number of times the user performed the desired behavior over a specified period of time, divided by the number of times the user is expected to perform the desired behavior over that period of time.

In these methods, the relationship between (i) the likelihood that a reward is provided or the value of the reward, and (ii) the user's behavior compliance rate can be described by a Spearman's rank correlation coefficient of less than zero, e.g., less than −0.5, or the value can be −1. In certain embodiments, the likelihood that a reward is provided, or the value of the reward, can be proportional to the difference between (i) the behavior adherence rate, (ii) and a specified number.

In another aspect, the invention includes TIR methods to determine intermittent reward(s) without an element of chance. These methods for obtaining a desired behavior from a user include generating a plurality of predetermined reward values, wherein each predetermined reward value is associated with a particular parameter, set of parameters, or range of parameters; determining, for a specific instance of the behavior, the current parameter; retrieving the reward value associated with the current parameter; and reporting whether a reward will be provided, and if so, the value of the reward.

For example, the methods can be computer-implemented TIR methods for obtaining a desired behavior from a user, and the methods are performed by one or more processors, e.g., via contact centers are described herein. These methods include generating and storing in a memory a plurality of predetermined reward values, wherein each predetermined reward value is associated with a particular parameter, set of parameters, or range of parameters; determining, for a specific instance of the behavior, the current parameter; retrieving the reward value associated with the current parameter; and reporting whether a reward will be provided, and if so, the value of the reward.

In certain embodiments, these methods can further include identifying the user and providing the report to that user, obtaining or maintaining a behavior adherence history for the user, calculating a behavior adherence rate from the behavior adherence history, and defining the current parameter as the behavior adherence rate.

The methods can further include identifying the user and retrieving the user's behavior adherence history, appending a record of the current behavior to the behavior adherence history, providing to the user a user identification code, and obtaining the user identification code to identify the user.

The DIR and TIR methods described herein can be used, for example, to improve medication adherence, e.g., to improve a user's, e.g., a patient's, regular use of medications prescribed to treat asthma, diabetes (e.g., control blood sugar levels), elevated blood pressure, elevated cholesterol, e.g., statins, and other long and short term medications.

In another aspect, the invention features systems for obtaining a desired behavior from a user using the DIR and TIR methods described herein. These systems include a contact center having a communications port, a processor, and an electronic apparatus readable medium configured to cause the processor to: identify the user via a communications network; receive a report of user's behavior via the communications network; and carry out any of the DIR and TIR methods described herein.

For example, the contact centers can include a communications port, a processor, a memory, and an electronic apparatus readable medium encoded with a program that when executed by the processor cause the processor to: identify the user via a communications network; receive a user report of a user's behavior via the communications network; determine and store in the memory a behavior adherence history for the user based on the user report; calculate a behavior adherence rate from the behavior adherence history; determine whether a reward should be provided; if a reward is to be provided, determine a reward value, wherein the value of the reward is inversely correlated with the behavior adherence rate; and provide the user with a reward report indicating whether a reward is to be awarded and if so, the reward value.

In these systems and methods, the electronic apparatus readable medium can be further configured to cause the processor to determine whether a desired behavior has occurred at an appropriate time and/or to cause the processor to report to the user when a behavior should be performed. In certain embodiments, the reward report can include, or is preceded or followed by, an informative or instructive message. The informative or instructive message can be selected from among a plurality of messages depending on the behavior compliance rate. The message may be the reward or reinforcement, even if no other reward is provided.

The systems described herein to perform the DIR and TIR methods can be used, for example, to improve medication adherence, e.g., to improve a user's, e.g., a patient's, regular use of medications prescribed to treat asthma, diabetes (e.g., control blood sugar levels), elevated blood pressure, elevated cholesterol, e.g., statins, and other long and short term medications.

As used herein, “intermittent reward” is defined as any method of reward wherein the nature, value, and/or frequency of reward differs, or can differ, between two or more occurrences of a specified behavior.

As used herein, “tailored reward” or “to tailor rewards” is defined as any method of reward wherein the nature, value, and/or frequency of reward is varied for, at least two different users in a plurality of users, or is varied over time for the same user.

As used herein, “inversely correlated” or “inverse correlation” is generally defined as any relationship, whether linear, nonlinear, univariate, or multivariate, between variables wherein lower values of one variable tend to be associated with higher values of another variable. In some embodiments, “inversely correlated” is defined as any relationship between two variables wherein the Spearman's rank correlation coefficient is less than 0. In certain embodiments, the Spearman's rank correlation coefficient is statistically significant. Spearman's rank correlation coefficient (sometimes known as Spearman's rho) is a widely used nonparametric method to assess the correlation between two variables; its application is familiar to anyone skilled in the art.

As used herein, a “Behavior Adherence History” is defined as any record of particular behaviors performed by a user, or not performed by user, or both, over time.

As used herein, “Behavior Adherence Rate” is defined as any numerical expression of desired behavior(s) performed by a user over a specified period of time.

As used herein, “sweepstakes” is defined as any promotion wherein an entrant can win a reward, and the reward depends on an element of chance.

As used herein, “to detect [a behavior]” or “detected [a behavior]” is defined as any method or process that determines or infers that a particular behavior has occurred or is likely to have occurred.

As used herein, “to report [a behavior]” or “reported [a behavior]” is defined as any method or process that communicates the occurrence of a particular behavior, whether confirmed or inferred. The communication may be between two persons, between two devices, or between a person and a device.

As used herein, “proof-of-purchase” is defined as any physical or electronic evidence, e.g., a receipt, coupon, voucher, Universal Product Code (UPC) symbol, bar code, container, document, printed matter, electronic transmission, electronic file, alphabetic, numeric, or alphanumeric or symbolic code, provided to a user with the purchase of a product or service, which the user may later proffer as evidence of said purchase.

As used herein, “user identification code” is defined as any information, e.g., serial number, identification number, social security number, name, address, telephone number, etc., useful for identifying a user.

The DIR systems and methods can be used to administer intermittent reward that is tailored to each individual and responsive to fluctuations in individual behavior over time. DIR has the tendency to optimize the frequency of a desired behavior over time and allows an operator to control the overall cost of rewards.

The TIR systems and methods can be used to administer intermittent reward without an element of chance, yet maintain the excitement of the contest and minimize the effects (if any) of individuals who seek to derive excessive rewards.

Both the new DIR and TIR methods and systems address problems that commonly occur in the practice of intermittent reward (cf. Examples 1-5). These problems include:

1. Consider a recurrent behavior that some people perform in the absence of intermittent rewards. Examples include exercise, adherence to a medication, the purchase of a product, compliance with a law, performance of a service, or payment of a fee or debt. Prior methods of intermittent reward tend to allocate much of the reward pool to instances of behavior that would have occurred even in the absence of rewards. In contrast, DIR can allocate more of the reward pool to promote new instances of the desired behavior (cf. Examples 1-2).

2. Prior methods of intermittent reward do not address situations in which a user's frequency of a desired behavior diminishes. DIR has the ability to increase the reward value or frequency automatically to improve the user's frequency of the desired behavior.

3. Prior methods of intermittent reward do not allow rewards that are specifically tailored for each user. DIR allows an operator to choose the most suitable reward values and frequencies for a user. This feature improves the ability of DIR to maximize a behavior frequency or to optimize cost-benefit considerations.

4. Prior methods of intermittent reward typically involve an element of chance. The new methods of TIR have the ability to maintain the “excitement” inherent to intermittent rewards without the element of chance (cf. Examples 3-5).

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features, objects, and advantages of the invention will be apparent from the description and drawings, and from the claims.

### DESCRIPTION OF DRAWINGS

FIG. 1 is a diagram of information flow between a user and a central computer via a communication network.

FIG. 2 is a schematic representation of a database of behavior records for a user.

FIG. 3 is a flow chart of an exemplary method of dynamic intermittent reward.

FIG. 4 is an example of five “Behavior Instance” records for a user.

FIG. 5 is an example of a “Static Table” for tabular intermittent reward.

FIG. 6 is an exemplary record of exercise sessions performed, exercise sessions scheduled, and statistics derived thereof for a hypothetical user.

FIG. 7 is a second example of a “Static Table” for tabular intermittent reward.

FIG. 8 is a schematic diagram of a behavior modification system.

FIG. 9 is a schematic diagram of an exemplary automated call center.

FIG. 10 is a schematic diagram of a communications network.

FIG. 11 is a graph illustrating results of the use of DIR to improve medication compliance.

FIG. 12 is a graph showing results of the use of DIR to improve timely refill of prescription medications.

FIG. 13 is a graph showing results of the use of DIR to improve medication compliance rates.

FIG. 14 is a graph showing results of the use of DIR to improve control of blood sugar in patients with diabetes.

FIG. 15 is a graph showing serial measurements of DIR parameters (Adherence Index and reward values) in an actual patient.

FIG. 16 is a graph showing the results of use of DIR to reduce the variable costs of a medication compliance program over time.

FIG. 17 is a graph showing the results of use of DIR to reduce the overall costs of a medication compliance program over time.

FIG. 18 is a graph showing the results of use of DIR to elicit repeated engagement by users over time.

FIG. 19 is a graph showing the results of use of DIR to elicit repeated engagement by users over time.

### DETAILED DESCRIPTION

This invention is based on novel approaches to provide intermittent reward to one or more users.

DIR includes systems and methods that tailor intermittent rewards in response to a user's behavior. DIR continually updates reward parameters over time as user behavior fluctuates. A feature of DIR is that the value or the frequency of reward, or both, tend to be inversely correlated with the frequency of a desired behavior. Generally, the less frequent the desired behavior, the more payoff is provided for each instance of the desired behavior. This feature, which may at first seem counter-intuitive, actually provides a powerful means to increase the frequency of a desired behavior and simultaneously control overall reward expenditures.

DIR is particularly useful for, but not necessarily limited to, behaviors that occur on a recurrent, scheduled basis. Common examples of such behaviors include: (1) use of medications (e.g., prescription medications for treating asthma, diabetes, elevated blood pressure, elevated cholesterol, e.g., statins, and other long and short term medications), medical or dental exams, vaccinations, and medical procedures; (2) maintenance or inspection of real property, motor vehicles (e.g., personal and fleet cars, and buses), machinery, and equipment; (3) purchase of any consumable product, commodity, or resource, such as food and drink, food service supplies, household supplies, water, metals, chemicals, lumber, paper, office supplies, fuel, electricity, heat, batteries, periodicals, and books; (4) purchase of products for which recurrent replacement is recommended, such as disposable contact lenses, toothbrushes, disposable razors, water filters, air filters, shocks, and mechanical belts; (5) purchase of recurrent services such as insurance, periodical subscriptions, club membership, haircuts, laundry, transportation, telecommunications, software, web site access, data access, property rental, auto rental, video rental, advertisements, trash disposal, and personal income tax returns; (6) use of safety equipment, safety practices, or cleanliness practices; (7) attendance at a school, course of instruction, health activity, e.g., tobacco cessation, diet, fitness activity (e.g., exercise class), or social activity; (8) performance at a school or in the course of employment, or under a contract; (9) payment of debts, particularly but not necessarily in installments, e.g., of a loan; (10) viewing of or listening to information, e.g., an advertisement or television program; (11) participation in a survey, scientific study, or questionnaire; and (12) compliance with a particular standard, such as maintenance of a particular body weight, body mass index, or caloric intake.

TIR includes systems and methods that make it possible to administer intermittent rewards in a varied manner without reliance upon an element of chance. A feature of TIR is the use of a “Static Table,” whereby each of a plurality of conditions is associated with a particular reward. TIR is useful in a wide array of circumstances for which it is desirable to administer rewards on an intermittent schedule.

### Detecting, Reporting, and Recording Behaviors

All embodiments of DIR and TIR require detection of a behavior, e.g., using some device or means to detect a behavior. Some embodiments require means to report or record a behavior, or both. Some embodiments require means to identify a user. Before the methods of DIR and TIR are described in detail, the means to detect, report, and record behaviors will be reviewed. The means to identify a user will also be reviewed.

Detecting Behaviors

Both the DIR and TIR methods provide a reward to a user in response to a desired behavior. There is therefore a need, common to both DIR and TIR, to detect the desired behavior.

A desired behavior can be detected in many ways. For example, a user, salesperson, supervisor, instructor, service provider, health care provider, or other can observe the behavior. Means by which a person, herein called “the observer,” can observe a particular behavior are well understood by one skilled in the art. For example: (1) an observer may directly observe the behavior, such as a clerk who oversees a customer's purchase of a product, or a teacher who checks class attendance; (2) an observer may receive direct evidence of the behavior, such as a proof-of-purchase or receipt, which would allow the observer to infer that a particular behavior has occurred; or (3) an observer may receive indirect evidence of the behavior, such as an improved blood pressure measurement in a patient who has faithfully taken her blood pressure medication.

A desired behavior can also be detected automatically. For example:

1. The purchase of a product can be detected when a Universal Product Code (UPC) bar code, membership card, or other printed matter or electronic medium is scanned at a point-of-sale terminal.

2. Computer records can be analyzed. For example, a record of a consumer's credit card use can be checked for each purchase of a specific brand of soft drink. Similarly, a student's transcript holds a record of his or her academic performance, which can be checked for each instance of an “A” earned in a course. Similarly, a user's visit to a website can be detected automatically by a host computer.

3. A wide array of sensors, familiar to those skilled in their respective arts, can be used to detect or infer the occurrence of a behavior:

(a) mechanical, optical, magnetic, sonic, or thermal sensors to detect the opening or closing of a door or container, or the location or movement of a person or item;

(b) radio frequency identification (RFID) tags to detect the location or movement of a person or item;

(c) a global positioning system (GPS) units to detect the location or movement of a person or item;

(d) scales to detect the weight of a person or material;

(e) monitors of physiologic function, such as heart rate, blood pressure, or oxygen saturation; and

(f) diagnostic medical devices, such as a glucose monitor.

Identifying the User

In some embodiments of DIR and TIR, there is a need to identify the user, i.e., he or she who performed the behavior. The user may be identified by his or her name, social security number, driver's license number, credit card number, membership number, prescription number, telephone number, address, electronic mail (e-mail) address, username, any other unique serial number, or any other suitable identifying number, code, or information.

In some embodiments of DIR and TIR, a user may be identified as a member of a class of users. Any suitable descriptor, identifying number, code, or information may be used to describe the class, e.g., zip code 02138, females 18 years or older, “Accounting Department,” “Loyalty Program Gold Member,” “Oak Hill Property Owners Association.” Furthermore, an entire class of individuals may collectively constitute “a user,” as herein described. Just as methods are described herein to tailor rewards to an individual user, the same methods may be used to tailor rewards to a class of users, whereby each member of the class may receive a common reward.

Reporting Behaviors

In some embodiments of DIR and TIR, the occurrence of a behavior, once detected, is reported to a remote entity, e.g., a central computer or a contact center. These embodiments therefore require the means to carry out such reporting.

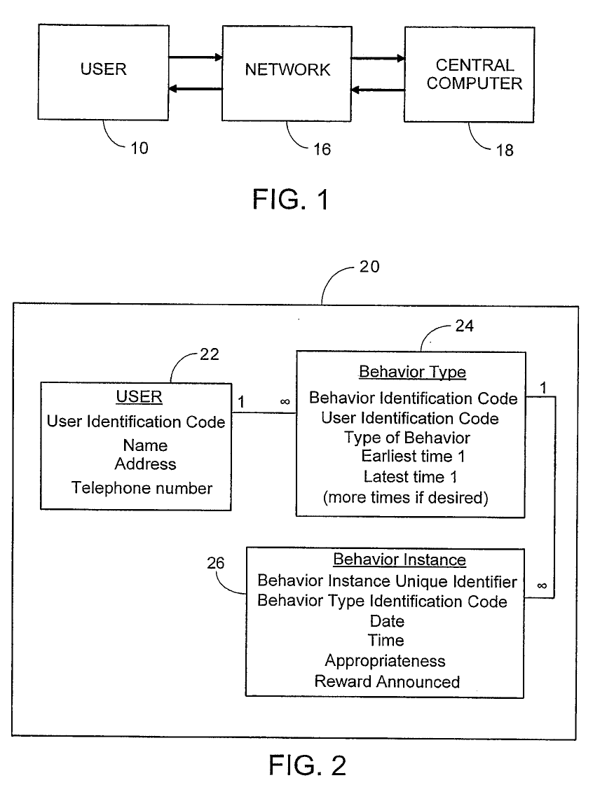

FIG. 1 shows one possible scheme for the flow of information between a user 10, communication network 16, and central computer 18. Note that the “user,” as shown in FIG. 1, could be substituted by another observer who has detected a behavior. The communication network can be any suitable means of communication between a user and a device or between two devices, e.g., a telephone system, a computer-based system such as the Internet, an intranet, or a local area network (“LAN”) or wide area network (“WAN”), e.g., within a hotel, school, office, or hospital, e.g., by email or “live chat.” The communication network can also be wireless, permitting contact by cellular or other mobile telephone, walkie-talkie, and other radio or infrared frequency devices.

### Communication Networks

The communication network 16 can comprise a telephone system, e.g., a mobile, wireless telephone system, an Internet-based system, or a closed wide area or local area network, e.g., within a school, hotel, hospital, office building, or clinic for use with a plurality of users. Although any communication network can be used, existing telephones (either land lines or wireless) and the Internet provide useful choices to receive contacts from and transmit data to the users of the new automated contact center systems.

These communication networks can use either wired or wireless interfaces such as computers, telephones, PDAs, and other Internet access devices. In general, to use a communications network such as the Internet or World-Wide-Web (WWW) an individual user runs a piece of software known as a Web browser, such as Internet Explorer® provided as part of the Windows® operating system from Microsoft Corporation. The individual interacts with the browser to select a particular URL of the ACC, which in turn causes the browser to submit requests or data to the server identified in the URL. Typically the server responds to the request by retrieving or generating the requested page and transmitting the data for the page back to the requesting individual. The content of the requested page may be either static or dynamic, whereby the latter can depend on mutable contents of a database or other information stored in memory or accessed from another device or network.

In parallel, the server may receive, store, process, and/or retransmit data submitted by the individual to the server. The individual/server interaction is performed in accordance with the hypertext transport protocol (“http”) or other suitable protocol. This page is then displayed on the individual screen. The client may also cause the server to launch an application. The above protocols are useful not only for transmitting information between an individual and a server, but also between two servers, or between an automated internet-compatible device and a server, or between two automated internet-compatible devices.

### Behavior Adherence History

In all embodiments of DIR and some embodiments of TIR, there is a need to record a user's behavior over a specified period of time. These embodiments therefore require a means to obtain or maintain a record, herein called a “Behavior Adherence History.”

As shown in FIG. 2, a Behavior Adherence History can be stored in a standard database 20 on a computer, e.g., a central computer (FIG. 1, reference 18). Any database (or even a simple variable array or flat text file) can be used, e.g., Microsoft SQL Server or Microsoft Access. A user's record of behavior is preferably stored as a time-and-date record.

The database 20 may comprise:

1. A table 22 called “User.” where each user has his or her own record, and whereby each record contains a “User Identification Code” and other desired identifying information.

2. A table 24 called “Behavior Type,” whereby each record contains a “Behavior Identification Code,” a User Identification Code, an optional description of the desired behavior, and an expression of the ideal or desired schedule for the behavior. In this example two variables are specified for a behavior to be performed over a set time period, e.g., a year, one or more months, a week, a 24-hour period, or a 12-hour period: the earliest time of day and the latest time of day. For example: “use dental floss,” earliest time 3 pm, latest time 11 pm. A twice-yearly car inspection could be: “Car inspection 1,” earliest date October 1, latest date November 30; “Car inspection 2,” earliest date April 1, latest date May 31. The schedule can be expressed in a variety of other ways obvious to a skilled artisan. A single record in “Individuals” can be related to one or many records in “Behavior Type.” In some embodiments, the actual time when the behavior is performed is not important, as long as the behavior is performed during a specific window of hours, days, weeks or month.

3. A table 26 called “Behavior Instance,” whereby each record corresponds to a single instance that the user has performed the desired behavior. Each record contains a “Behavior Instance Unique Identifier,” a Behavior Identification Code, a date or time or both, the reward provided (if any), and an optional Appropriateness field. The “Appropriateness” field, which can carry values such as “on-time” or “not on-time,” is determined by comparing the time in the “Behavior Instance” record with the earliest and latest times or dates in the related “Behavior Type” record, as would be obvious to anyone skilled in the art. A single record in “Behavior Type” can be related to one or many records in “Behavior Instance.”

### Dynamic Intermittent Reward (DIR)

A first aspect of the invention is Dynamic Intermittent Reward (DIR). DIR comprises any method of intermittent reward wherein the value of the reward, or the likelihood that a reward will be awarded, is inversely correlated with a user's frequency of desired behavior(s). The frequency of desired behavior is typically determined from a Behavior Adherence History. This inverse relationship between a desired behavior and reward value or frequency may at first seem counterintuitive, but it has useful and unexpected properties.

DIR is typically implemented with mathematical functions to modulate reward frequency and value. For a user who performs a desired behavior infrequently, DIR tends to provide above-average reward(s) to the user until the behavior becomes more frequent. Under these circumstances, this elevated cost of rewards is counterbalanced by the user's low frequency of the desired behavior, which means he or she “misses out” on many rewards. As the user responds to the rewards and behavior frequency improves, the payoff returns to normal levels. At the same time, a user who performs the behavior at a desired frequency tends to have more opportunities to win, so the system can, if an operator so desires, be designed to treat users with different behavior patterns differently yet equitably. Any time a user's frequency of a desired behavior diminishes, DIR can “come to his or her aid,” i.e., respond with extra reward(s). Under such circumstances, the user's pre-conditioned behavior is expected to return rapidly to peak levels. To render it more interesting to the user, DIR can include other features, such as random “noise” and “super-rewards” such as an automobile or vacation.

Some implications of DIR are as follows:

(1) Each time a user with an inferior behavior pattern (i.e., less frequent desired behavior) performs a desired behavior, he or she tends to receive more incentive, or is more likely to receive an incentive, compared to one with a superior behavior pattern. The amount of incentive or likelihood thereof is positively correlated with the degree of behavior inferiority.

(2) Each time a user with a superior behavior pattern (i.e., more frequent desired behavior) performs a desired behavior, he or she tends to receive less incentive, or is less likely to receive an incentive, compared to one with an inferior behavior pattern; and the amount of incentive or likelihood thereof is inversely correlated with the degree of behavior superiority.

(3) When a user modifies his or her behavior by performing a desired behavior either more or less often than before, the reward value or frequency (or both) is updated in an iterative fashion, based on the rules outlined above.

(4) When a user with an inferior behavior pattern receives a substantial or increased reward, he or she will tend to respond with an improved behavior pattern. DIR then reduces the reward value or frequency (or both) in an iterative fashion, based on the rules outlined above.

(5) When they perform a desired behavior, individuals with inferior behavior patterns tend to receive more incentives compared to those with superior behavior patterns. At the same time individuals with superior behavior patterns incur lower reward expenditures, compared to those with an inferior behavior pattern, when they perform a desired behavior.

(6) Given the phenomenon in (5), DIR is particularly useful in scenarios where individuals may have other motives to perform a desired behavior.

Under DIR there will be a tendency for each person to reach an equilibrium with respect to reward value and behavior frequency. Reward values and frequencies can be modulated, even individually, to influence where this equilibrium occurs. A clear benefit of this approach is that an operator can direct most of the funds in a finite pool to those who represent new instances of a desired behavior, rather than to those people who would perform the desired behavior even in the absence of a reward. Another novel benefit of the system is that it provides more incentive to those people who need it most. Finally, another useful property is that the system responds rapidly and automatically to a user's fluctuations in behavior in a way that will entice the user to return to a desired frequency of behavior.

It is helpful to contrast DIR with conventional intermittent reward as well as continuous reward. Conventional methods of intermittent reward (such as a lottery) do not allow different, tailored reward frequencies to help individuals who need relatively more motivation. Continuous reinforcement, on the other hand, involves fixed rewards, for example, $3 per dose. To reward individuals sufficiently with either of these approaches is likely to be prohibitively expensive. DIR, on the other hand, motivates each user at reasonable costs for the overall system.

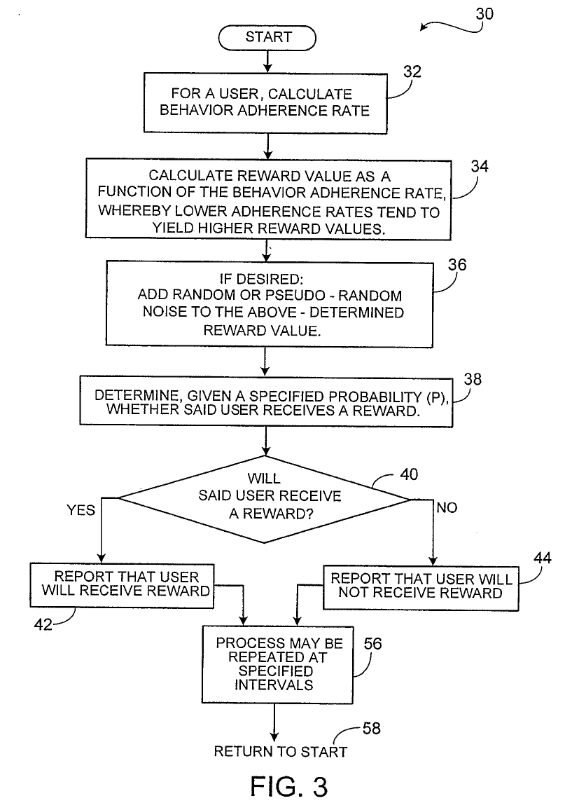

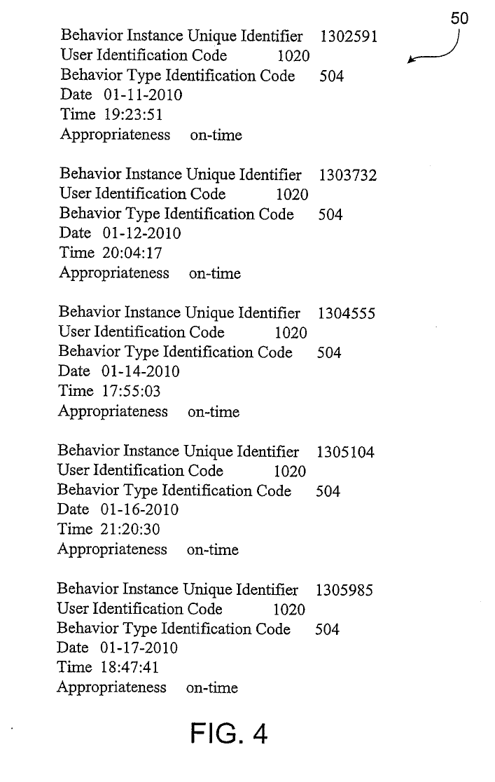

A detailed method to implement DIR is described below and exemplified in FIGS. 3 and 4. FIG. 3 shows an exemplary method 30 to administer Dynamic Intermittent Reward (DIR) for a user. The method 30 is conducted each time a user is eligible for a reward (or it can be conducted ahead of time, with the results stored for later use). Steps 32, 34, and 36 relate to the assignment of a Reward Value, and step 38 relates to the assignment of Reward Given, i.e., whether the user will receive a reward on that particular occasion. In FIG. 3 step 38 occurs after steps 32, 34, and 36, but it should be understood that step 38 could also be conducted before or in parallel with steps 32, 34, and 36.

In step 32 a Behavior Adherence Rate (BAR) is calculated from the Behavior Adherence History. A representative method would be to divide the number of instances a behavior was performed on-time during a given time period (e.g., the number of daily disposable contact lenses used by a patient over the last 7 days) by the number of behavior instances prescribed during the same time period (e.g., 14 contact lenses, i.e., one for each eye, over the last 7 days). A patient who uses 10 daily disposable contact lenses in 7 days would have a BAR of 10/14=0.714.

The next step 34 is to calculate a reward value (“Reward Value”) as a function of the BAR calculated in step 34. This calculation should tend, on a stochastic basis, to yield an inverse correlation between the BAR and the reward value. For example, the reward value can be calculated as $100 multiplied by (1.1−BAR).

The next step 36 is to add “noise,” if desired, to the reward value. The purpose of the noise is to add an additional level of interest for the user. For example, one can multiply the reward by the value R, whereby R is a uniformly distributed random number between 0 and 2.

The next step 38 is to determine whether the user will receive a reward or not for the particular instance of desired behavior in question (“Reward Given,” “RG”). Detailed methods are explained below. For example, assume that the desired probability of a reward is 0.33 and further assume a uniformly distributed value RG between 0 and 1, whereby the user will receive a reward if and only if RG<P. The output of steps 32-38 is evaluated at branchpoint 30. If the user is to receive a reward (step 42), a “reward report” occurs, i.e., the user or another party is notified of the reward, or the reward is credited automatically, as described above; this may optionally make use of a communication network (FIG. 1: 16) or central computer (FIG. 1: 18). The user can repeat the process at specified intervals (step 46), returning (step 48) to the starting state. If the user is not to receive a reward (step 44), the user or another can be notified, if desired, and the user can repeat the entire process at specified intervals (step 46), returning (step 48) to the starting state.

For each occurrence of a desired behavior, or at a different interval if desired, the Behavior Adherence History can be analyzed to determine rewards as follows. For each instance of desired behavior, a user's Behavior Adherence History is analyzed to determine if the user obtains a reward and if so, of what value. Alternatively, these parameters can be calculated ahead of time and recorded in anticipation of the user's next instance of desired behavior.

An exemplary system determines whether the user receives a reward for a particular instance of desired behavior. First, a Reward Frequency (RF) can be specified, where RF is between 0 and 1, inclusive. For example, RF=0.35 would correspond to a reward frequency of 35%. For a particular instance of desired behavior, a simple way to determine whether the user receives a reward is by the following test:

| | |
|---|---|
| IF (RAND( ) < RF) | THEN (Reward Given = yes) |
| | ELSE (Reward Given = no) |

where RAND( ) is a uniformly distributed pseudo-random number between 0 and 1. The user receives a reward for the present instance of desired behavior if and only if Reward Given=yes.

With the above test, the actual frequency with which individuals obtain rewards will only approximate RF. If a way is desired to make the actual frequency precisely the same as RF, many methods exist that are well-known to those skilled in the art. For example, an variable array of 100 elements can be constructed. Each element of the array can contain a value of 0, 1, or 2. If RF=0.35, then elements 1-35 are set to contain a 1, and elements 36-100 are set to contain a 0. Now, for a particular instance of desired behavior, one of the 100 elements is chosen at random. If the value in that element is 1, then Reward Given=“yes.” Otherwise, Reward Given=“no.” The value in that element is then set to 2 to indicate that the element has been used. For another instance of desired behavior, the process is repeated, with the proviso that if a chosen element contains a value of 2, then another element is chosen at random, and the process continues. When all elements contain a value of 2, i.e., when the sum of all elements is 200, all elements are reset to values of 0 or 1, based on RF, as described above, and the process repeats as above.

The above tests can be modified so that the reward frequency is modulated depending on user characteristics. For example, the following test would render a higher probability of providing a reward to a user with a lower Behavior Adherence Rate (BAR):

| | |
|---|---|
| IF (RAND( ) < RF/BAR) | THEN {Reward Given = yes}; |
| | ELSE {Reward Given = no} |

Any of several possible functions or series can be used instead of RAND( ) as a pseudo-random number generator. Such functions or series, while not random, can be designed to yield virtually unpredictable results for a user. For example:

f(x)=TRUNC(π log x)

where TRUNC is the decimal portion of the expression in parentheses, log is the natural logarithm, and x is any varying, positive real number. Furthermore, if desired, a function can be used to transform RAND( ) to a normally distributed parameter.

Alternatively, instead of a reward frequency, the intermittent nature of the reward can be expressed in terms of a “Reward Ratio” (e.g., one reward for every three instances of a desired behavior) or “Reward Delay” (e.g., after winning, user must register three more instances of a desired behavior before winning again). Again, any of several possible functions or series could be used instead of RAND( ) as a pseudo-random number generator. For example:

Reward Delay (in days)=MOD(êx, maximum_delay)

Where MOD is the modulus of êx with maximum_delay as the divisor, êx represents “e” raised to the exponential power x, e is the base of the natural logarithm, x is any real number, and “maximum_delay” represents the maximum possible value returned by the above function.

If a user is to receive a reward for a particular instance of desired behavior, it is also necessary to determine the amount of the reward. To make this determination, a Behavior Adherence Rate is calculated from the user's Behavior Adherence History. FIG. 4 is an exemplary Behavior Adherence History, shown as a table 50 of records for all instances of a desired behavior over the last 7 days by user John Smith (User Identification Code 1020) for use of his treadmill (Behavior Identification Code 504).

To calculate the Behavior Adherence Rate (BAR) it is first necessary to specify over what period of time adherence is to be calculated. For this example, referring to FIG. 4 the BAR can be calculated for the 7-day period of Jan. 11, 2010 through Jan. 17, 2010. Assume that it is known from a “Behavior Type” table, similar to table 24 of the database 20 (see FIG. 2), that John should use his treadmill once every evening. From this information it follows that the BAR for the specified period is 5/7=0.7143.

In this manner, the BAR can be calculated for the past week, past month, or any other desired period of time. Note that the BAR, as it applies to the “past week,” will vary with each new day, as the definition of the “past week” is updated in a so-called “moving-window average.” In this case BAR will be a number between 0 and 1 inclusive. Likewise, values of BAR can be calculated for the week before the past week, the week before that, and so on.

In some embodiments more sophisticated functions can be used to incorporate records acquired over longer periods of time. If desired, a function can weigh recent behavior more heavily than remote behavior. For example, suppose that a user's Behavior Adherence History is kept for over 5 weeks, and a Behavior Adherence Rate (BAR) is calculated for each of the last 5 weeks. Further suppose results as follows:
Past 7 days 0.714
1 week prior 0.571
2 weeks prior 0.857
3 weeks prior 0.429
4 weeks prior 0.714

From the above values an expression of behavior, herein called the Adherence Index (AI) can be calculated by a geometric series as follows:

AI=BAR (past 7 days)/2+BAR (1 week prior)/4+BAR (2 weeks prior)/8+BAR (3 weeks prior)/16+BAR (4 weeks prior)/32=0.714/2+0.571/4+0.857/8+0.429/16+0.714/32=0.656.

If sufficient data are available, the series can be expanded to include six or more terms. The Adherence Index (AI) will be a number between 0 and 1 inclusive. Just as an AI can be calculated based on present-day data, AI also can be calculated based on the data 7 days earlier or for any other period in the past where data are available. In the above example, an AI calculated on the data 7 days earlier would be approximately:

AI=0.571/2+0.857/4+0.429/8+0.714/16 . . . =approximately 0.598.

Note that in the above example, AI serves as a substitute for the Behavior Adherence Rate. A skilled artisan will appreciate that other functions can be substituted for those above, with the same essential result of expressing a user's behavior over time.

Once a Behavior Adherence Rate is calculated, then the value of reward can be calculated. As noted above, this calculation can occur either before, after, or in parallel with the calculation of Reward Given. A useful approach to calculate the reward value is first to specify a Base Reward (BR), for example, $100. The final Reward Value (RV) can then be calculated, for example as:

Reward Value (RV)=BR*(1−AI)*RAND( )

where RAND( ) is a uniformly distributed (pseudo-)random number between 0 and 1. For example, if BR=$100, AI=0.656, and RAND( )=0.601:

Reward Value (RV)=$100*(1−0.656)*0.601=$20.67.

Many other functions can be used to serve the purpose of determining a reward value from the above parameters. The essential requirements are (1) a base reward value; and (2) a Behavior Adherence Rate. Optionally, the formula may also include a random, pseudorandom, or other expression that varies (and whose distribution is not necessarily uniform). One or more of the above parameters can be compared or normalized with respect to other individuals in the database, or for other time periods for the same user. For example, it may be desirable to normalize RV or BR across all individuals in the database, to control the overall value of rewards to be issued.

The principles of DIR dictate that the RV will tend, on a probabilistic basis, to be lower for higher values of AI. Likewise RV will tend to be higher for lower values of AI. Other expressions could be substituted for the (1−AI) in the above equation and still preserve the concept of DIR, for example (1/AI). Another useful approach is |TA−AI|, meaning the absolute value of the difference between TA and AI, where TA refers to a specific Target rate of behavior adherence between 0 and 1.

In certain implementations, the Reward Value can be further transformed or evaluated to serve other useful purposes. For example, it may be desirable to provide a higher reward to individuals whose AI has recently improved. A method to accomplish this would add another term to the Reward Value equation, such that:

Reward Value (RV)=BR*(1−AI)*RAND( )*UF̂(10*(AI(today)−AI(7 days ago)))

where UF (the “Uprise Factor”) is a coefficient typically between 1.0 and 3.0.

The Uprise Factor is a parameter set by the operator. With an Uprise Factor of 3.0, an improvement in AI over the past week would tend, on a probabilistic basis, to be associated with higher values of RV. With an Uprise Factor of 1.0, the expression UF(10*(AI(today)−AI(7 days ago))) would be equal to 1 and would not affect the Reward Value.

### Tabular Intermittent Reward (TIR)

Circumstances exist wherein it is desirable to calculate Reward Value ahead of time for a plurality of anticipated conditions and store these values in a table (a “Static Table”) for later use (see Examples 4-5). This approach, herein called Tabular Intermittent Reward (TIR), can be used with almost any method of intermittent reward. Particular advantages to this approach are that once a Static Table is generated, it is possible to determine with mathematical certainty under which condition(s) a user will or will not receive a reward, and what the value of the reward will be. That is, for any person who possesses the Static Table (or necessary portion thereof), rewards will be predictable and therefore non-random. At the same time, however, a Static Table makes it possible to vary rewards over time in a manner that while predictable is both varied and interesting to a user, allowing the “excitement” that users typically derive from traditional intermittent rewards. The main overall advantage of using a Static Table is that it should, by virtue of having predictable outcomes, be able to avoid some of the difficulties occasioned by conducting a game of chance (i.e. sweepstakes).

In certain embodiments, the Static Table can, if desired, be made available to the user. Then, if a user so desires, he or she can determine ahead of time whether the desired behavior will result in a reward, and if so, how much. He or she can therefore make an informed decision whether said behavior would be “worth the effort” of his or her behavior. The invention further contemplates an optional service, e.g., an Internet site or toll-free telephone hotline, whereby a user could find out ahead of time whether he or she would win a reward on a particular occasion for performing a particular behavior. Such a system, albeit counter-intuitive at first glance, would be particularly useful for its ability to give the participant free choice and avoid an element of randomness.

One way to implement Tabular Intermittent Reward is to construct a table, herein called a “Static Table,” which contains N+1 records, wherein N is any whole number, e.g., 10 or more. In one embodiment, each record lists values for the same three variables. The first variable, Behavior Adherence Bin, is an integer between 0 and N inclusive, whereby the records contain consecutive integer values from 0 to N, and whereby the record with Behavior Adherence Bin=0 corresponds to AI=0, and the record with Behavior Adherence Bin=N corresponds to AI=1.0. For example, if N=10, then the record with Behavior Adherence Bin=3 could correspond to the interval of 0.30≦AI<0.4, and the record with Behavior Adherence Bin=5 could correspond to the interval of 0.50≦AI<0.6. This example assumes that the different values of Behavior Adherence Bin represent equal intervals of AI; however, this provision is not necessary and in some circumstances it can be desirable to let different values of Behavior Adherence Bin correspond to unequal intervals of AI.

The second variable is Base Reward, as described above.

The third variable is Reward Given (yes or no, as described above). For each value of Behavior Adherence Bin, Base Reward, and Reward Given values can be calculated based on AI=(Behavior Adherence Bin/N). The table can be recalculated periodically, if desired, for example daily, weekly, or monthly. Each user can have his or her own unique table, or the same table can be used for a plurality of users. For each occasion one wishes to determine Base Reward and Reward Given, one refers to the table and refers to the record whereby Behavior Adherence Bin=INT (AI*N), whereby the function INT, commonly known in computer parlance, is one which rounds the expression in parentheses down to the nearest integer. The corresponding values of Base Reward and Reward Given are then obtained from the same record.

Other types of Static Tables can be constructed. For example, Behavior Adherence Bin can be designed to depend on other parameters, such as BAR (see above), the day of the week, the user's weight, or even relatively arbitrary values such as the temperature recorded at a specified location every day at noon. The column of Base Reward could be replaced with a Column for Reward Value. Furthermore, the Static Table would work equally well if it used the product of Base Reward (or Reward Value) and Reward Given (let “yes”=1 and “no”=0) rather than the two factors individually. Alternatively, two or more tables could be created and used for different conditions (for example, a different table for each day of the week). The essential concept in all of these tables is that the Reward Given (yes or no) and/or some measure of reward value are calculated ahead of time, so that it is not necessary to a evaluate a random or pseudo-random expression in connection with a particular instance of desired behavior.

The following example illustrates how Tabular Intermittent Reward and Dynamic Intermittent Reward can be used together with respect to a user's exercise behavior.

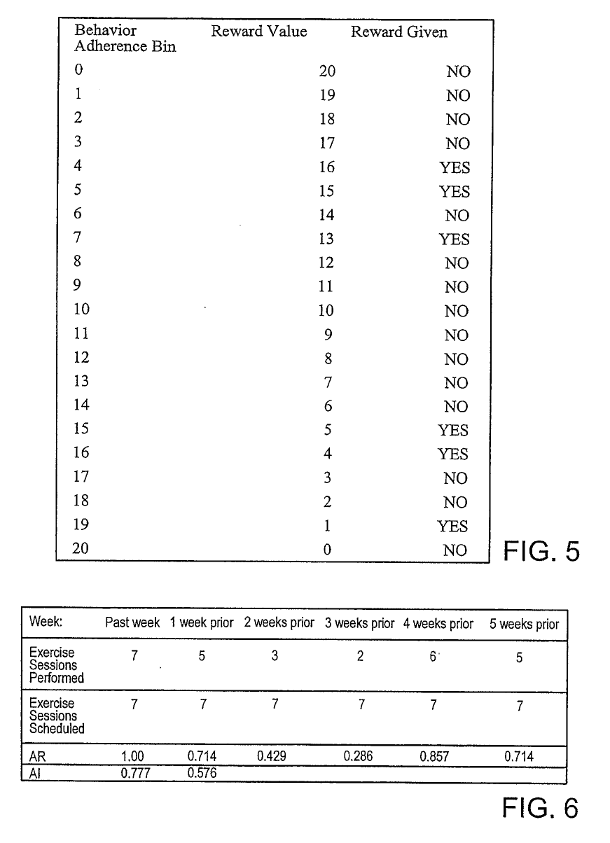

FIG. 5 shows an exemplary Static Table with 21 values for Behavior Adherence Bin and their associated values of Base Reward and Reward Given. For this table, consistent with the concept of Dynamic Intermittent Reward, Reward Value has been defined as:

Base Reward=20−Behavior Adherence Bin

where Behavior Adherence Bin is defined as above by the Adherence Index. Note that based on this equation, Base Reward is inversely correlated with the Adherence Index.

In this example Reward Frequency will be specified as 30%, and it happens that by the methods recited above, 6 of 21 Behavior Adherence Bins correspond to Reward Given=Yes. The other Behavior Adherence Bins correspond to Reward Given=No.

For this example let us now consider a user Joe, who is supposed to perform daily exercise on a treadmill. FIG. 6 summarizes his Behavior Adherence History, which provides information as follows:

AI (past week)=0.777 and AI (previous week)=0.576.

Since AI=0.777 corresponds to Behavior Adherence Bin=INT (20*0.777)=15:

Reward Value=5 and Reward Given=Yes.

For this example, let BR=$10, UF=1.5, and:

Reward Value=BR*RM*BM*UF^{(10*(AI}^{₀}^{-AI}^{₁}⁾⁾

Therefore: Reward Value=$10*0.421*1*1.5̂(10*(0.777−0.576))=$4.21*2.259=$9.51.

### Variations on TIR

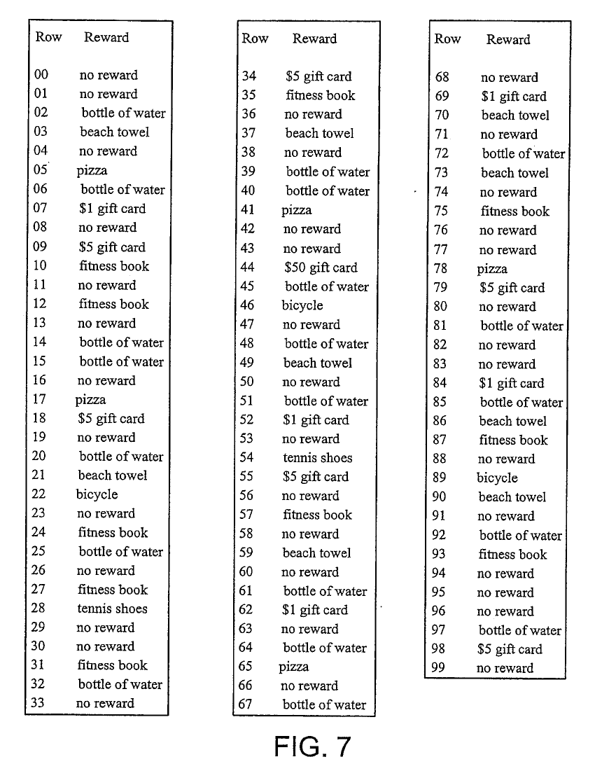

The Static Table, such as that shown in FIG. 5, can be revised or replaced, for example every week. As described above for Dynamic Intermittent Reward, the contents of the table can be modified to promote particular behaviors. A Static Table does not necessarily have to use 21 rows; it can use fewer rows (such as 10) or more rows (such as 100 or more). All of the above variables can be calculated on a monthly basis or some other period of time, rather than weekly. As shown in FIG. 7, the Static Table can work equally well if it uses a product of Base Reward (or Reward Value) and Reward Given (let “yes”=1 and “no”=0) rather than the two factors individually.

Static Tables such as those shown in FIGS. 5 and 7 do not necessarily need to be constructed by any mathematical or rational method. Rather, they can be based upon any scheme or fancy of one who authors them.

It should be noted that Tabular Intermittent Reward or Reinforcement (TIR) and Dynamic Intermittent Reward or Reinforcement (DIR) can be used separately or together. TIR can be used with many available methods of intermittent reward. DIR can be used with an element of chance, if desired.

### Behavior Modification Systems

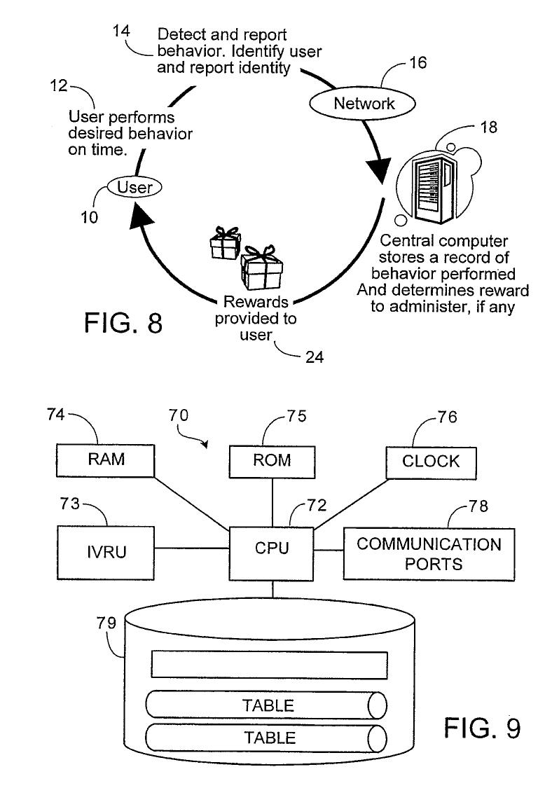

FIG. 8 depicts a behavior modification system useful for the implementation of DIR, TIR, or both. A user 10, e.g., a consumer, employee, patient, or student, performs a desired behavior 62. At step 64 the desired behavior is detected, the user is identified, and the behavior and user identity are reported, preferably over a communication network 16, to a central computer 18.

When a desired behavior is reported, the central computer 18 employs the methods of DIR, TIR, or both, explained elsewhere in this application. If DIR methods are used, the input comprises the user's Behavior Adherence History. If TIR methods are used, the input comprises one or more parameters to choose the proper row from a Static Table. The input will typically also include information to identify the user.

The output is a Reward Report, i.e., whether the user 10 is to receive a reward, and if so, the value of the reward. If the central computer 18 so determines, a reward is provided (step 24) to the user 10. The reward can be in the form of a payment, product, service, or recognition. The receipt of the reward occurs upon preferably automatic notification by the central computer 18, e.g., a reward coupon can be sent automatically or communicated to the user or a merchant, or the user's account can be credited electronically. Optionally, this communication can occur over a communication network such as 16.

The reward report can also include an informative or instructive message, and this message can vary depending on the Behavior Adherence Rate. For example, a patient with an excellent history of using hypertension medication may receive a report as follows: “Thank you for continuing to treat your blood pressure.” In contrast, a patient with a history of poor medication compliance may receive a report as follows: “Even if you feel fine, high blood pressure may be damaging your blood vessels today.” As another example, a user with a Behavior Adherence Rate of 0.8 or more may hear a recorded message from a celebrity, whereas another user with a Behavior Adherence Rate of less than 0.8 may hear one with a standard voice.

### Automated Contact Centers (ACC)

The new behavior modification systems may include one or more control or contact centers, e.g., automated contact centers (ACC) that users or observers can contact via any form of communication network. The ACC is useful for a number of purposes: (1) behavior reports; (2) implementation of DIR or TIR, and (3) reward reports.

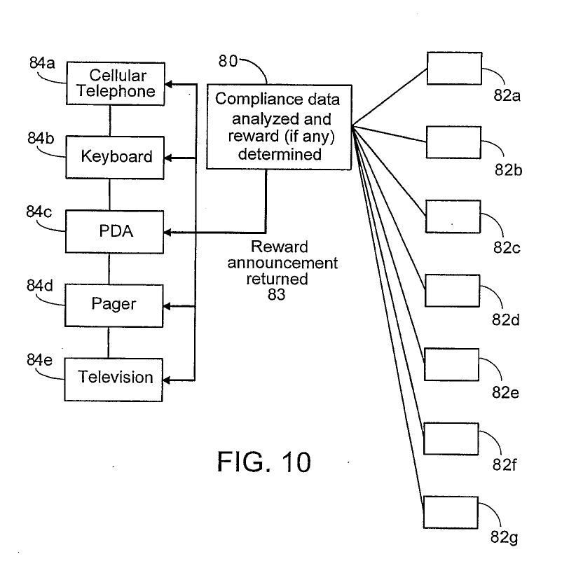

The new ACCs, as well as the various algorithms for DIR and TIR described above, can be implemented in hardware or software, or a combination of both. The invention can be implemented in computer programs using standard programming techniques following the method steps and figures disclosed herein. As shown in FIG. 9, the programs should be designed to execute on a programmable central computer 70 each including at least one processor 72, at least one data storage system (including volatile and non-volatile memory and/or storage elements, e.g., RAM, 74 and ROM, 75), at least one communications port 78, that provides access for devices such as a computer keyboard (84b, FIG. 10), telephone (84a, FIG. 10), or a wireless, hand-held device, such as a PDA (84c, FIG. 10), and optionally at least one output device, such as a monitor, printer, or website. The central computer 70 also includes a clock 76 and optionally an interactive voice response unit (“IVRU”) 73. These are all implemented using known techniques, software, and devices. The system also includes a database 79 that includes data, e.g., in the form of tables, for user data, behavior event data, and, in some embodiments, Behavior Adherence History.

Program code is applied to data input by a user (e.g., user identification codes and reward codes; some of this information may be automatically determined by the system based on the user's telephone number using standard caller ID protocols) and data in the database, to perform the functions described herein and generate output information, such as whether a reward has been obtained and the value of the reward. The system can also generate inquiries and provide promotional messages to the user. The output information is applied to one or more output devices through the communications port 78 to devices such as a telephone, printer, or a monitor, or a web page on a computer monitor with access to a website.

Each program used in the new methods is preferably implemented in a high-level procedural or object-oriented programming language to communicate with a computer system. However, the programs can be implemented in assembly or machine language, if desired. In any case, the language can be a compiled or interpreted language.

Each such computer program is preferably stored on a storage medium or device (e.g., RAM, ROM, optical, magnetic) readable by a general or special purpose programmable computer, for configuring and operating the computer when the storage media or device is read by the computer to perform the procedures described herein. The system can also be implemented as a computer-readable storage medium, configured with a computer program, whereby the storage medium so configured causes a computer to operate in a specific and predefined manner to perform the functions described herein.

The new ACCs and methods can be implemented using various means of data storage. For example, the individual user and behavior event data files can be stored on a computer-readable medium (electronic apparatus readable medium) or in a computer or other electronic memory. The files can be transferred physically on recordable media or electronically, e.g., by email on a dedicated intranet, or on the Internet. The files can be encrypted using standard encryption software from such companies as RSA Security (Bedford, Mass.) and Baltimore®. The files can be stored in various formats, e.g., spreadsheets or databases.

As used herein, the term “electronic apparatus” is intended to include any suitable computing or processing apparatus or other device configured or adapted for storing data or information. Examples of electronic apparatus suitable for use with the present invention include stand-alone computing apparatus; communication networks, including local area networks (LAN), wide area networks (WAN), Internet, Intranet, and Extranet; electronic appliances such as personal digital assistants (PDAs), cellular telephones, pagers and the like; and local and distributed processing systems.

As used herein, “stored” refers to a process for encoding information on an electronic apparatus readable medium. Those skilled in the art can readily adopt any of the presently known methods for recording information on known media to generate products comprising the sequence information.

A variety of software programs and formats can be used to store reward, user, and other data on an electronic apparatus readable medium. For example, the data can be represented in a word processing text file, formatted in commercially-available software such as Microsoft® Word®, or represented in the form of an ASCII file, stored in a database application, such as Microsoft Access®, Microsoft SQL Server®, Sybase® Oracle®, or the like, as well as in other forms. Any number of data processor structuring formats (e.g., text file or database) can be employed to obtain or create a medium having recorded thereon the relevant data and information.

By providing information in electronic apparatus readable form, one can routinely access the information for a variety of purposes. For example, one skilled in the art can use the data in electronic apparatus readable form to compare a specific set of data provided by a user with the information stored within a database. For example, search programs, such as character recognition programs, can be used to identify characters or series of characters in information provided by a user that match a particular reward or user code.

### EXAMPLES

The following examples are not to be construed as limiting in any fashion.

### Example 1

### Problems Inherent to Intermittent Reward

Suppose that a town council wishes to improve the physical fitness of the town's residents. The council institutes a free daily aerobic exercise class and desires attendance of 100 people per day. A month after the class is instituted, a study shows that actual attendance has averaged only 65 people per day, of whom 60 profess to be “fitness lovers” and attend the class every day. The town council wishes to boost attendance from 65 to 100 per day and therefore hires a consultant. The consultant advises the council to offer intermittent rewards to people who attend the exercise class. The council decides to hold a free random drawing each day, whereby 1 in 10 people who attend the class each win $10 cash. In response to the random drawing, average daily attendance rises to 80. A study, however, shows that the “fitness lovers,” who constitute 60 out of 80 in the class, collect an average of 75% of the prizes. The consultant points out that the town council pays an average of $80 daily, but this induces only 15 new people to attend ($5.53 in overall daily expense divided by number of new participants). As a result, the “fitness lovers” collectively earn an average of $60 per day, but the people for whom the incentives were chiefly intended collectively earn only an average of $20 per day. The consultant also professes that the effect of the rewards will “wear off,” in that attendance is likely to fall below the average of 80 per day despite continued reward expenditures. The consultant predicts that under these circumstances the proportion of “fitness lovers” to new members will rise over time, and “fitness lovers” will in turn collect proportionately more rewards.

The council is pleased that there are 60 “fitness lovers” in the town but disheartened that these “fitness lovers” collect all the rewards, which were actually intended to motivate others in the town who do not practice healthy lifestyles on their own accord. As a possible solution, the consultant recommends that the random drawing be limited to the first month a person attends the aerobics class. The council implements this recommendation, but a further study shows that many of the new members quit after one month, when their rewards end. Meanwhile, two former “fitness lovers” now appear less motivated, and their attendance has fallen by 30%. The council asks the consultant if there is a method to address the above problems. The council also asks if there is a way to optimize the reward process automatically and on a repeated basis.

### Example 2

### Dynamic Intermittent Reward to Promote Community Exercise

Consider Example 1, where the town council sponsored intermittent rewards at an exercise class. To address the problems seen in Example 1, the town council implements a new method of Dynamic Intermittent Reward (DIR) as described herein. A method of DIR is chosen that awards to 20% of individuals, randomly selected, rewards of $20 minus $1 for each aerobics class a user has attended over the previous 18 days. With this approach, a winning “Fitness Lover” with perfect attendance receives a reward of $2. In contrast, a winning person with a record of poor attendance (or a person new to the aerobics class) receives a reward of $15 to $20. A winner of $15 to $20 is likely to be motivated to attend the next day, and the next day, and so forth. In time this person's attendance record would tend to improve, and the rewards would diminish in a concomitant manner. In fact, this person's attendance is more likely to become or resemble “perfect attendance,” which would dictate rewards of as little as $2. Should this person's attendance then worsen, the simple expression above would once more lead to an increased reward. The reward amounts would continue to respond to the user's attendance record.

In response to the implementation of DIR, average daily attendance at the exercise class increases to 110 participants. Meanwhile, average collective daily expenditures are reduced to $44 per day (down from $80 per day in Example 1). With DIR the council pays only $0.88 per day for each new participant recruited (overall daily expense divided by number of new participants), substantially better than the $5.53 per day paid in Example 1. The DIR-supported system is 6.38 times more cost-effective.

### Example 3

### Circumstances Surrounding Sweepstakes

The owner of a for-profit health club decides to employ intermittent reward to recruit and retain customers and further popularize exercise in her community. The owner decides to carry out a sweepstakes wherein: (1) each time a club member checks in at the front desk, he or she can draw one ticket from a box; (2) each ticket has a 1 in 10 chance to win a prize; and (3) the prizes vary in value from $1 to $1,000. Within one month, the sweepstakes proves a success: new enrollment increases by 20% and monthly profits increase by 35%. However, the owner of the health club discovers that it is unlawful to conduct a promotion which requires a purchase (i.e., a club membership) and awards prizes based on chance.

The club owner therefore decides to provide an Alternative Method of Entry (AMOE), whereby any non-member can also participate in the promotion. The club owner institutes an AMOE, whereby non-members as well as members can draw one ticket daily from the box. The health club owner soon notices that each day approximately 100 customers from a nearby supermarket, who are not members of the fitness club, enter the club and draw a ticket from the box. The tickets in the box, which were supposed to suffice for 3 months, are depleted within 1 month. Most of the prizes are claimed by people who were never members of the club. The owner of the fitness club finds, in the final analysis, that her business has lost money due to the sweepstakes promotion. She decides to research possible methods to provide intermittent rewards that do not depend on an element of chance.

### Example 4

### Tabular Intermittent Reward (TIR) at a Fitness Center

To address the problems seen in Example 3, the owner of the health club implements a new method of Tabular Intermittent Reward (TIR).

She chooses to construct a “Static Table” with 100 rows, numbered consecutively 00 to 99 (FIG. 8). As shown in FIG. 8, each row also lists a corresponding reward or “no reward,” where applicable. Each time a club member completes a session on an exercise machine (e.g., computerized stationary bicycle, treadmill, or elliptical trainer), club personnel record the virtual “distance” traveled during the session, as measured in miles and displayed to two decimal places by the exercise machine. The member is entitled to a reward, if applicable, listed in the row corresponding to the last digits of the average heart rate; e.g., an average 105 beats per minute corresponds to the reward listed in row 05 (a “pizza”); an average of 168 beats per minute corresponds to the reward listed in row 68 (“no reward”). The health club discloses the method of reward determination to anyone who wishes to see it.

### Example 5

### Tabular Intermittent Reward (TIR) at a Retail Store

The CEO of a chain of retail stores decides to apply TIR to a store promotion. The promotion uses the “Static Table” shown in FIG. 8, whereby consumers have a chance to receive a reward for each purchase over $20. The reward is determined from the row corresponding to the two-digit number of “cents” in the final price of the purchase. For example, a final purchase price, including tax, of $27.49 would correspond to row 49 (“beach towel”). A final purchase price of $38.55 corresponds to row 55 (“$5 gift card”).

### Example 6

### DIR and TIR to Promote Medication Compliance

DIR and TIR were implemented to promote on-time use of a “statin” medication in 20 customers of a pharmacy in the Boston area. Each time a patient used his or her medication, he or she had an opportunity to accrue a reward by DIR. A Behavior Adherence History, in the form of a daily record of medication use, was acquired by means of an automated contact center and maintained for each patient on a computer database. Each day that the patient contacted the automated contact center, an Adherence Index (AI) was calculated, as described above, and the patient received a reward report, with the reward dependent on the Adherence Index. Rewards were determined from a 100-row static table, similar to that shown in FIG. 7, with the “row” determined by the Adherence Index and all rewards expressed as a number of points between 0 and 500, whereby 100 points were redeemable for approximately $1 of merchandise.

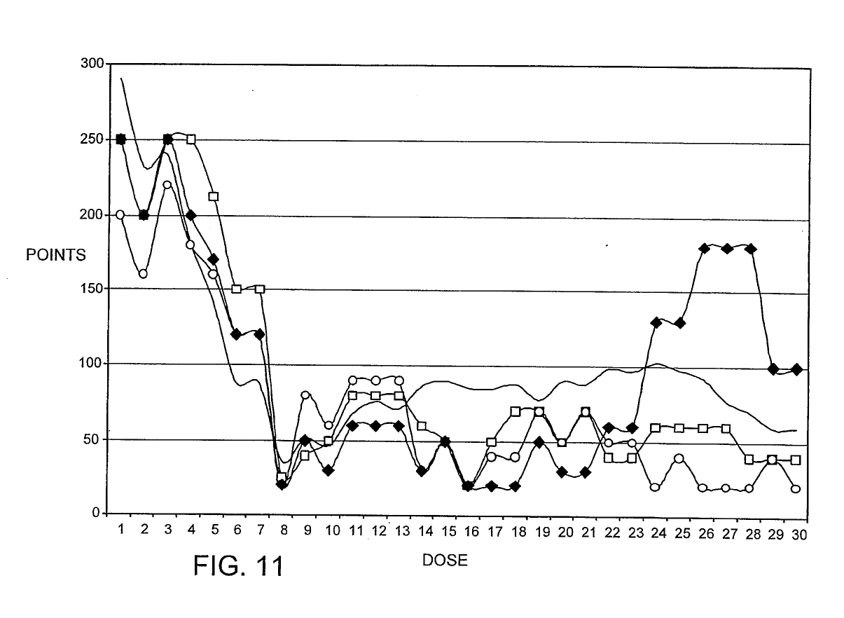

To summarize the results, FIG. 11 shows the number of points awarded over time to the overall sample as well as representative patients. The x-axis denotes which dose, from a sequence of 30 pills. Most patients in the sample tended to take one dose daily, i.e., on the correct schedule, whereas some patients occasionally allowed two or more days to elapse between doses. The chart shows results for 30 consecutive doses, whether they were taken once daily or more sporadically. The y-axis shows the number of reward points provided, with values smoothed for clarity (as a 5-dose moving average).

The heavy solid line without symbols shows the mean for all patients. DIR had the desired effect, in that the number of reward points diminished over time, and yet the patient continued to use the medication without interruption. The overall rate of medication adherence in the sample was 93%. This controlled cost and yet maintained appropriate medication compliance.

The line denoted with open circles and the line denoted with open squares correspond to individual patients who used their medication every day or almost every day. These patients provide individual examples of how DIR had the desired effect.

The line denoted with filled diamonds denotes a patient who used the medication on a daily basis until dose 23. The points awarded declined appropriately until dose 23. At this point, due to the Christmas holiday, the patient skipped several consecutive days. The first time the patient resumed medication after this hiatus, DIR responded with increased point values. This had the desired effect, as the patient then maintained daily medication use. By dose 27, DIR appropriately reduced costs with lesser reward values. The patient continued to use the medication on a daily basis.

### Example 7

### DIR Used to Improve Medication Compliance in a Real-World Asthma Population

Pharmacy claims data were compared for actual patients prescribed a particular asthma inhaler and enrolled in one of the following programs:

(1) neither of the programs below (“no intervention,” n=7887);

(2) a brand's existing relationship program (“non-DIR intervention,” n=7899); or

(3) the above non-DIR intervention program plus a DIR system (“DIR,” n=154).

The “non-DIR intervention” was a web-based relationship management (RM) program that patients could use to learn about their disease, medication, and pollen counts in their geographic location. Another feature of the “non-DIR intervention” program included a medication reminder system where patients could sign up to receive regular email or SMS-text reminders to take their medication.

Patients in the “no intervention” category were matched to those in the “non-DIR intervention” category based on age, gender, co-pay status, and insurance type.

The DIR system used in this program consisted of a voluntary opportunity for patients to confirm, up to twice daily, that they had taken their prescribed medication. Upon such confirmation of medication adherence, the system calculated their new Adherence Index (AI) and, based on the updated AI, delivered an educational message and points based on the AI. The new AI was also displayed to the patient. Points were redeemable every two months for health-oriented items such as health-related books and fitness equipment.

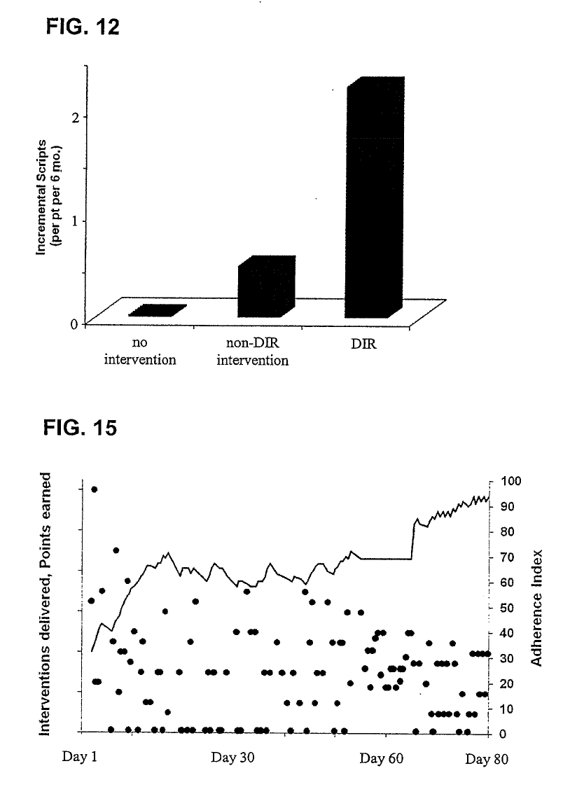

FIG. 12 shows the number of additional prescriptions filled by each of the three groups for the 6 months following the start date of each program relative to the 6 months preceding the start date of each program. For the “no intervention” category, the start date coincides with that of the “non-DIR intervention” program. As shown in FIG. 12, DIR was associated with an increase of over 2.2 prescriptions per 6-month period. Little or no improvement was observed in the other categories.

### Example 8

### DIR Used to Improve Medication Compliance and Blood Sugar Control in a Real-World Diabetes Population

Pharmacy claims for diabetes medications were examined for patients enrolled in a DIR program, in which they were invited and allowed to interact repeatedly with a DIR system. Claims were analyzed for up to 18 months preceding the date of enrollment (“before DIR”), and up to 6 months following the date of enrollment (“with DIR”), depending on the availability of claims data for each individual. A Medication Possession Ratio (MPR) was calculated based on the following formula: (# days of medication dispensed/# days elapsed from the date of fill of the prescription until the refill of the next prescription).

Patients were identified through electronic medical records, recruited through direct mailings of informational brochures, and enrolled through the internet and a telephonic interactive voice recognition (IVR) system as part of a Contact Center. The DIR system used in this program consisted of a voluntary opportunity for patients to confirm that they had taken their prescribed medication. The maximum allowed frequency of these interactions was between one and four times daily, depending on the prescription medication schedule. Upon such confirmation of medication adherence, the system calculated their new Adherence Index (AI) and, based on the updated AI, delivered an educational message and points based on the AI. The new AI was displayed to the patient. Points were redeemable every 30 days for particular gift cards.

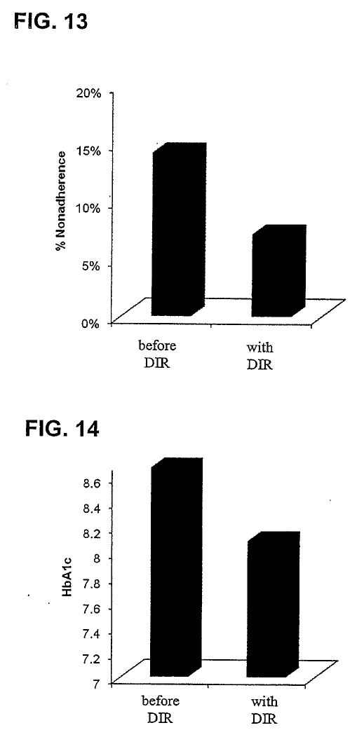

FIG. 13 shows the results. Results are expressed as percent non-adherence (1−MPR for each prescription). 102 patients had a total of 1170 claims in the “before DIR” group, and 47 patients had a total of 124 pharmacy claims in the “with DIR” group. The “before DIR” group had an average non-adherence of 14.20% and the “with DIR” group had an average non-adherence of 7.10% (p=0.00042, 2-tailed t-test).

A control group of patients (n=78) who did not enroll in the DIR program was also examined; these patients did not show a statistically significant change in non-adherence during the duration of the program (not shown in FIG. 13).

Claims were also reviewed for measurements of hemoglobin A1c (HbA1c), an established measure of month-to-month blood sugar control in diabetes. FIG. 14 shows the results. Laboratory claims data were examined for patients enrolled in the DIR program for up to 18 months preceding the date of enrollment (“before DIR”), and up to 9 months following the data of enrollment (“with DIR”), depending on the availability of claims data for each individual. 144 patients had a total of 474 HbA1c claims in the “before DIR” group and 99 patients had a total of 159 HbA1c claims in the “with DIR” group. The “before DIR” group had an average HbA1c of 8.668 and the “with DIR” group had an average HbA1c of 8.085 (p=0.0011, 2-tailed t-test).

A control group of patients (n=532) who did not enroll into the DIR program was also examined and found to not show a statistically significant change in HbA1c during the duration of the program (not shown in FIG. 14).

### Example 9

### DIR Used to Maintain Engagement and Reduce Average Cost Over Time in an Actual Patient with Diabetes

FIG. 15 shows the results of interactions between an actual, representative diabetes patient and the DIR system mentioned in Example 8 above. The user's date-of-contact and points earned for each contact are shown by filled circles (left y-axis), and the user's Adherence Index (AI) is plotted by the solid line (right y-axis) from Mar. 18 to Jun. 18, 2009 (x-axis). Note that the user repeatedly (and voluntarily) used the system, and that the DIR system and methods delivered intermittent reinforcement (AI improved from about 30% to over 90%), while reducing the average cost (points earned) of each contact (use) over time.

### Example 10

### DIR Used to Reduce Costs Over Time and Maintain Patient Engagement in a Real-World Asthma Population

Patients were recruited through internet search engine advertisement placement (banner ads), direct mailings, and other channels used by the brand's customer relationship management (CRM) marketing. Patients enrolled by filling out a set of registration questions on the internet at a Contact Center. The DIR system used in this program consisted of a voluntary opportunity for patients to confirm that they had taken their prescribed medication up to twice per day. Upon such confirmation of medication adherence, the system calculated their new Adherence Index (AI) and, based on the updated AI, delivered an educational message and points based on the AI. The new AI also was displayed to the patient.

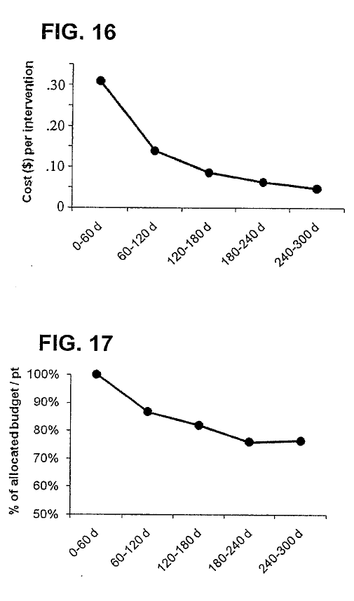

FIG. 16 shows the mean cost per use of a DIR system (intervention) for real-world asthma patients prescribed a particular inhaler, as a function of days elapsed since program enrollment. Note that variable costs of the DIR system declined progressively over time from just over $0.30 per intervention at 0-60 days to about $0.05 per intervention at 240-300 days.

FIG. 17 shows data obtained from the same population in terms of the percent of allocated budget spent per time period. Note that overall costs of the DIR system (i.e., both fixed and variable) declined progressively over time from 100% to under 80% by 180-240 days and stayed under 80% through 240-300 days.

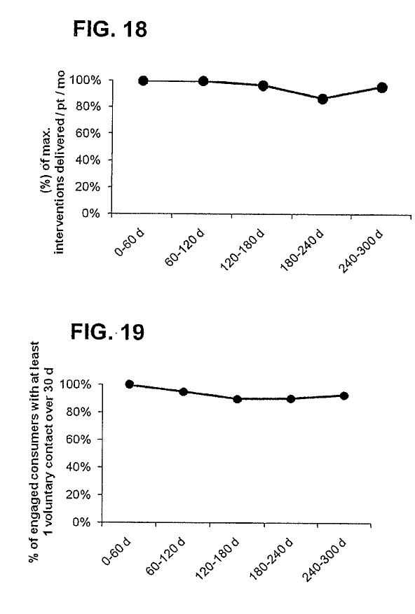

FIG. 18 shows that over the same period of time (300 days), and despite diminishing mean reward values, patients maintained consistent levels of engagement (expressed here as percent of the maximum number of uses per month by a particular patient in any one-month time period).

FIG. 19 shows that nearly all patients remained engaged with the system during this 10-month period, where engagement was defined as a least one use of the system per month.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A computer-implemented method for obtaining a desired behavior from a user, the method performed by one or more processors and comprising:
storing in a memory a behavior adherence history for the user;
calculating a behavior adherence rate from the behavior adherence history;
determining whether a reward should be provided;
if a reward is to be provided, determining a reward value, wherein the value of the reward is inversely correlated with the behavior adherence rate; and
providing the user with a reward report indicating whether a reward is to be awarded and if so, the reward value.

2. The method of claim 1, further comprising:
identifying the user and retrieving the user's behavior adherence history.

3. The method of claim 2, further comprising:
recording a most recent behavior in the user's behavior adherence history.

4. The method of claim 2, further comprising:
providing to the user a user identification code; and
obtaining the user identification code to identify the user.

5. The method of claim 1, wherein the behavior adherence rate is calculated by
determining a first number of times the user performed the desired behavior over a specified period of time, and
dividing the first number of times by a second number of times the user is expected to perform the desired behavior over the period of time.

6. The method of claim 1, wherein a relationship between (i) a likelihood that a reward is provided or the value of the reward, and (ii) the user's behavior adherence rate is described by a Spearman's rank correlation coefficient of less than zero.

7. The method of claim 1, wherein a relationship between (i) a likelihood that a reward is provided or the value of the reward, and (ii) the user's behavior adherence rate is described by a Spearman's rank correlation coefficient of −1.

8. A system for obtaining a desired behavior from a user, comprising a contact center comprising:
a communications port,
a processor,
a memory, and
an electronic apparatus readable medium encoded with a program that when executed by the processor causes the processor to:
identify the user via a communications network;
receive a user report of a user's behavior via the communications network;
determine and store in the memory a behavior adherence history for the user based on the user report;
calculate a behavior adherence rate from the behavior adherence history;
determine whether a reward should be provided; if a reward is to be provided, determine a reward value, wherein the value of the reward is inversely correlated with the behavior adherence rate; and
provide the user with a reward report indicating whether a reward is to be awarded and if so, the reward value.

9. The system of claim 8, wherein the electronic apparatus readable medium is further configured to cause the processor to determine whether a desired behavior has occurred at an appropriate time.

10. The system of claim 8, wherein the electronic apparatus readable medium is further configured to cause the processor to report to the user when a behavior should be performed.

11. The system of claim 8, wherein the reward report further comprises, or is preceded or followed by, an informative or instructive message.

12. The system of claim 11, wherein the informative or instructive message is selected from among a plurality of messages depending on the behavior adherence rate.

13. A computer-implemented method for obtaining a desired behavior from a user, the method performed by one or more processors and comprising:
generating and storing in a memory a plurality of predetermined reward values, wherein each predetermined reward value is associated with a particular parameter, set of parameters, or range of parameters;
determining, for a specific instance of the behavior, the current parameter;
retrieving the reward value associated with the current parameter; and
reporting whether a reward will be provided, and if so, the value of the reward.

14. The method of claim 13, further comprising:
obtaining a behavior adherence history for the user;
calculating a behavior adherence rate from the behavior adherence history; and
defining the current parameter as the behavior adherence rate.

15. The method of claim 13, further comprising:
identifying the user and retrieving the user's behavior adherence history.

16. A system for obtaining a desired behavior from a user, comprising a contact center comprising:
a communications port,
a processor,
a memory, and
an electronic apparatus readable medium encoded with a program that when executed by the processor causes the processor to carry out the steps of the method of claim 13.

17. The system of claim 16, wherein the electronic apparatus readable medium is further configured to cause the processor to determine whether a desired behavior has occurred at an appropriate time.

18. The system of claim 16, wherein the electronic apparatus readable medium is further configured to cause the processor to report to the user when a behavior should be performed.

19. The system of claim 16, wherein the reward report further comprises, or is preceded or followed by, an informative or instructive message.

20. The system of claim 19, wherein the informative or instructive message is selected from among a plurality of messages depending on the current parameter.
